(19) United States
(12) Patent Application Publication
(10) Pub. No.: US 2021/0285524 A1
(43) Pub. Date: Sep. 16, 2021

(54) CHECK VALVE AND INTEGRATED PRESSURE RELIEF VALVE CONTROLLED BY A METALLIC BAND

(71) Applicant: BorgWarner Inc., Auburn Hills, MI (US)

(72) Inventors: Toru SHINOYAMA, Yamatokoriyama Nara (JP); Jeremy BENN, Auburn, NY (US); Dale N. SMITH, Freeville, NY (US); Seongdo HONG, Ithaca, NY (US)

(21) Appl. No.: 16/325,038

(22) PCT Filed: Aug. 16, 2017
(86) PCT No.: PCT/US2017/047101

§ 371 Date: Feb. 12, 2019

(51) Int. Cl. F16H 7/08; F01L 1/02; F16K 15/04; F16K 39/02

(52) U.S. Cl. CPC F16H 7/08; F01L 1/022; F01L 1/024; F16K 15/044; F16H 2007/0806; F16H 2007/0814; F16H 2007/0872; F16H 2007/0893; F16H 2007/0897; F16K 39/026

(57) ABSTRACT

An integrated valve for a hydraulic tensioner includes a pressure relief valve with an integrated band, which is preferably made of metal, placed around the outside of a pressure relief valve body. A hydraulic tensioner includes a housing with a bore and a hollow piston slidably received within the bore. A piston spring biases the piston in a direction toward a power transmission device. The tensioner also includes an integrated check valve in a body of the housing. The integrated check valve includes a pressure relief valve mechanism and a band check valve mechanism surrounding a circumference of the pressure relief valve mechanism. The pressure relief valve mechanism permits transfer of pressurized fluid from a piston chamber formed by the hollow piston to the source of pressurized fluid and the check valve mechanism permits transfer of pressurized fluid from the source of pressurized fluid to the piston chamber.

### BACKGROUND OF THE INVENTION

### Field of the Invention

The invention relates to an integrated pressure relief valve apparatus and more particularly to a hydraulic tensioner for applying proper tension to an endless, flexible, power transmission member, such as a timing belt or timing chain, encircling a driving sprocket and at least one driven sprocket as used for an internal combustion engine of a motor vehicle.

### Description of Related Art

Chain tensioners in engines are used to control the power transmission chains as the chain travels around a plurality of sprockets. The slack of the chain varies as the temperature in an engine increases and as the chain wears. When a chain wears, the chain elongates and the slack in the chain increases. The increase in slack may cause noise, slippage, or tooth jumping between the chain and the sprocket teeth. If the increase of the slack of the chain is not taken up, by a tensioner for example, in an engine with a chain driven camshaft, the engine may be damaged because the camshaft timing is misaligned by several degrees due to slippage or tooth jumping.

The performance of a hydraulic tensioner is based on two primary functions of a check valve. First, oil must flow through a check valve and into a high pressure chamber of the tensioner as the piston extends to take up chain slack. If the flow restriction of the check valve is too great, the piston will not have enough oil volume to support its extended length. Secondly, as the chain begins to push the piston back into the tensioner the oil wants to flow back out of the check valve. At this point, the oil passage must be sealed off. Current technology utilizes a single check valve ball for sealing this passage. If the response time is too slow it takes longer to build up the necessary pressure to support the piston and chain control becomes an issue.

Hydraulic tensioner check valves have been previously disclosed in U.S. Pat. Nos. 7,404,776; 7,427,249; and U.S. Published Application No. 2008/0261737. The current singular check valve ball technology is limited in that it has two methods of increasing flow. The first option is to increase the diameter of the ball which increases the conical flow area between the seat and ball. The adverse effect of increasing the ball diameter is that the ball's mass also increases. As the mass of the ball increases the response time to reverse the direction of the ball to seal off the inlet aperture also increases. The second method of increasing the flow is to increase the travel distance of the ball. Allowing the ball to move further away from the seat will increase the conical flow area, but it also means response time will increase. Neither of these methods provides variable flow. A hydraulic tensioner with a band check valve is disclosed in US Patent Publication No. 2008/0293526.

U.S. Pat. Nos. 5,700,213 and 5,707,309 show pressure relief valves for hydraulic tensioners. The valve designs in these patents suffer from an inability to create a small, compact lightweight valve that is also cost effective.

### SUMMARY OF THE INVENTION

A pressure relief valve for a hydraulic tensioner includes an integrated band check valve. The check valve function is controlled by a metallic band placed around the outside of the relief valve body.

In one embodiment, an integrated check valve for a hydraulic tensioner includes a pressure relief valve mechanism and a band check valve mechanism. The pressure relief valve mechanism includes a hollow pressure relief body defining a chamber, the pressure relief body having a first end with an aperture, a second end, and a length extending from a bottom portion, a valve member received in the first end of the chamber, a pressure relief retainer received in the second end of the chamber, and a first biasing member received in the chamber having a second end contacting the pressure relief retainer and a first end contacting the valve member, the first biasing member biasing the valve member to a position in which the valve member seals the aperture of the pressure relief body. The check valve mechanism includes a check valve retainer surrounding a portion of the length of the hollow pressure relief body comprising a retainer sidewall and a retainer top wall defining through holes, where the check valve retainer defines a cavity between the pressure relief valve body and the check valve retainer, and at least one band check valve received within the cavity and extending around an outside of the pressure relief body between the top wall of the check valve retainer and the bottom portion of the pressure relief valve body. In some embodiments, the integrated check valve further includes a vent seal adjacent the pressure relief valve mechanism defining a plurality of holes to permit forward and back flow of pressurized fluid. In other embodiments, a hole adjacent the pressure relief valve mechanism permits forward and back flow of pressurized fluid.

In another embodiment, a hydraulic tensioner for an endless loop, flexible, power transmission member for an internal combustion engine of a motor vehicle includes a housing having a bore, the bore having an inner surface, the housing having an inlet in communication with a source of pressurized fluid, a hollow piston slidably received within the bore, the piston having an inner surface and an outer surface, a piston spring biasing the piston in a direction toward the power transmission device, a hydraulic pressure chamber formed between the inner surface of the bore, the inner surface of the hollow piston, and an integrated check valve in a body of the housing, comprising a pressure relief valve mechanism and a band check valve mechanism surrounding a circumference of the pressure relief valve mechanism. The pressure relief valve mechanism permits transfer of pressurized fluid from the hydraulic pressure chamber to the source of pressurized fluid and the check valve mechanism permits transfer of pressurized fluid from the source of pressurized fluid to the hydraulic pressure chamber.

In another embodiment, a band check valve assembly for a hydraulic tensioner includes a hollow cylindrical inner valve body having a length extending from a bottom portion and comprising a cylindrical inner valve body sidewall defining at least one through hole, and an inner valve body top wall, a check valve retainer surrounding a portion of the length of the cylindrical inner valve body comprising a retainer sidewall and a retainer top wall defining through holes, where the check valve retainer defines a cavity between the cylindrical inner valve body and the retainer sidewall, and at least one band check valve received within the cavity and extending around an outside of the hollow cylindrical inner valve body between the retainer top wall and the bottom portion of the cylindrical inner valve body. The band check valve assembly preferably provides forward flow of pressurized fluid through the band check valve assembly such that fluid flows from a source through the at least one through hole in the inner valve body and through the through holes of the check valve retainer.

In yet another embodiment, a hydraulic tensioner for an endless loop, flexible, power transmission member for an internal combustion engine of a motor vehicle includes a housing having a bore, the bore having an inner surface, the housing having an inlet in communication with a source of pressurized fluid, a hollow piston slidably received within the bore, the piston having an inner surface and an outer surface, a piston spring biasing the piston in a direction toward the power transmission device, a hydraulic pressure chamber formed between the inner surface of the bore, the inner surface of the hollow piston and a band check valve assembly in a body of the housing. The band check valve assembly includes a hollow cylindrical inner valve body having a length extending from a bottom portion and comprising a cylindrical inner valve body sidewall defining at least one through hole, and a inner valve body top wall, a check valve retainer surrounding a portion of the length of the cylindrical inner valve body comprising a retainer sidewall and a retainer top wall defining through holes, wherein the check valve retainer defines a cavity between the inner cylindrical inner valve body and the retainer sidewall, and at least one band check valve received within the cavity and extending around an outside of the hollow cylindrical inner valve body between the retainer top wall and the bottom portion of the cylindrical inner valve body. The band check valve assembly permits transfer of pressurized fluid from the source of pressurized fluid to the hydraulic pressure chamber.

### BRIEF DESCRIPTION OF THE DRAWINGS

FIG. 1 shows a hydraulic tensioner.

FIG. 2 shows an integrated pressure relief valve in an embodiment of the present invention.

FIG. 3 shows a tensioner including an integrated pressure relief valve with a vented assembly in the closed position.

FIG. 4 shows a close up view of the integrated pressure relief valve in the tensioner of FIG. 3 with the pressure relief valve open.

FIG. 5 shows a close up view the integrated pressure relief valve in the tensioner of FIG. 3 with the band check valve open.

FIG. 6 shows a tensioner including an integrated pressure relief valve with a vented assembly in the closed position.

FIG. 7 shows a close up view of the integrated pressure relief valve in the tensioner of FIG. 6 with the pressure relief valve open.

FIG. 8 shows a close up view of the integrated pressure relief valve in the tensioner of FIG. 6 with the band check valve open.

FIG. 9 shows a band check valve assembly for a hydraulic tensioner.

FIG. 10 shows a section view of the band check valve assembly of FIG. 9.

FIG. 11 shows a band check valve assembly in a hydraulic tensioner.

FIG. 12 shows a close up view of the band check valve assembly of FIG. 9 in a tensioner.

### DETAILED DESCRIPTION OF THE INVENTION

An integrated valve includes a pressure relief valve with an integrated band check valve (also known as a band valve or a band type check valve) surrounding the pressure relief valve. The check valve function is controlled by a band, which is preferably metallic, placed around the outside of the pressure relief valve body. These low cost and space saving valves have a one-way valve function and a pressure relief function which are separated The band check valve is placed around the pressure relief valve on a circumference to minimize packaging space. By using simplified component parts, low cost valves are achieved.

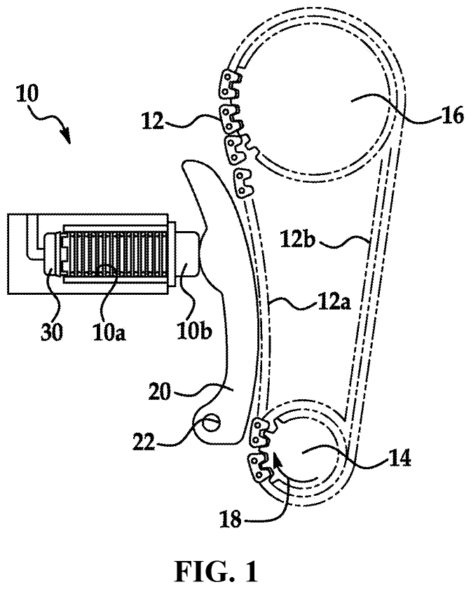

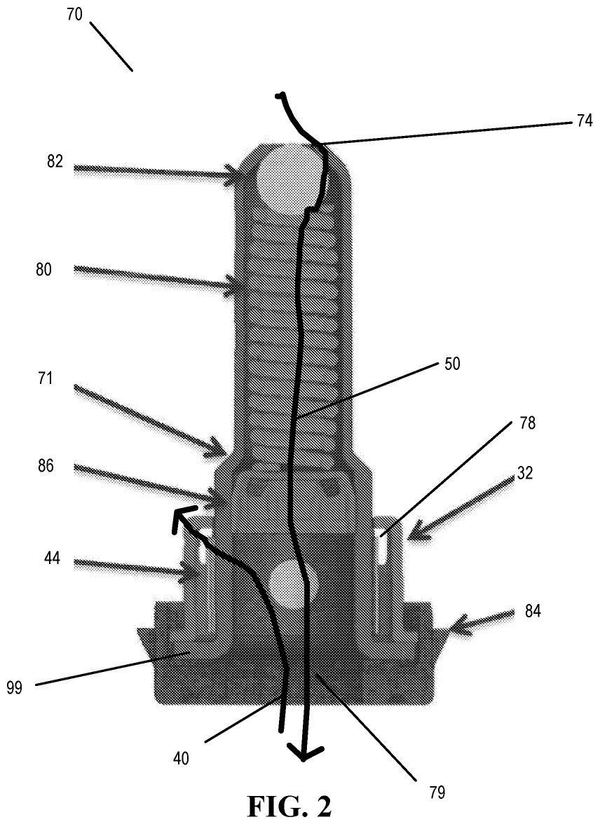

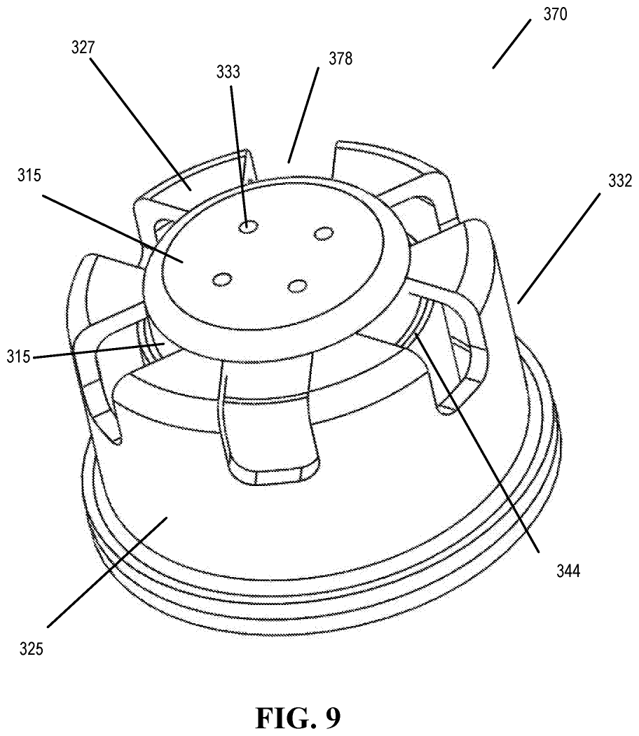

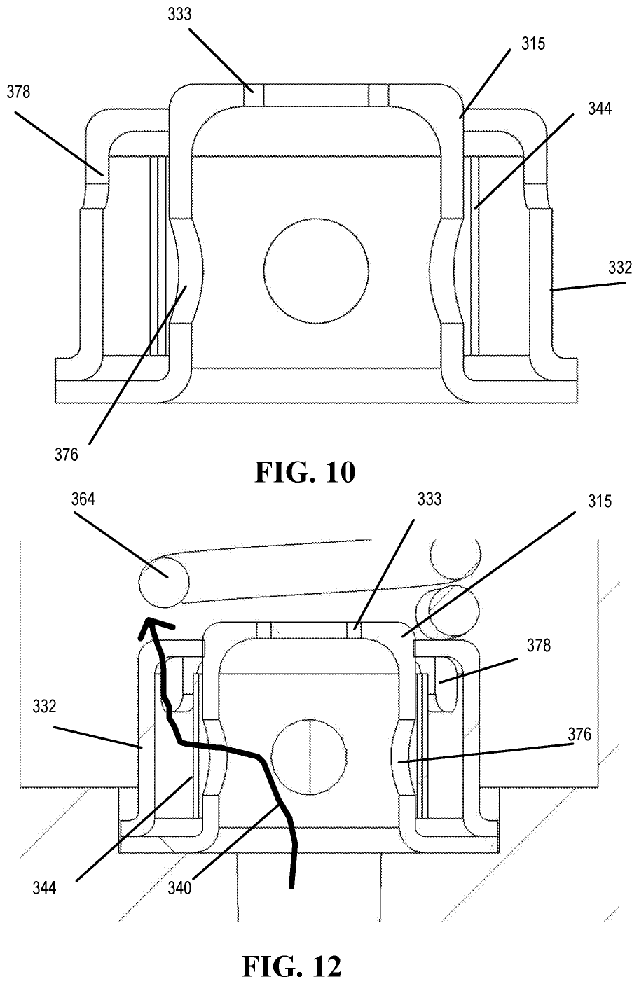

FIG. 1 schematically illustrates a hydraulic tensioner 10 for an endless loop, flexible, power transmission member 12 for an internal combustion engine of a motor vehicle. The power transmission member 12 encircles a drive sprocket 14 driven by a drive shaft, such as a crank shaft of the engine, and at least one driven sprocket 16 supported from a driven shaft, such as a cam shaft of the engine. A guide roll can also be provided, if desired. The power transmission member 12 passes over the drive sprocket 14 and driven sprockets 16 to define a slack strand 12a and a taut strand 12b, when driven in rotation as shown by arrow 18. On the outside of at least one of the slack strand 12a and the taut strand 12b of the power transmission member 12, at least one tensioning arm 20 is positioned with a face assembly including a shoe for sliding engagement with the power transmission member 12. The tensioning arm 20 can rotate about pivot 22 in response to force exerted by the tension drive mechanism or hydraulic tensioner 10. Rotation of the tensioning arm 20 about the pivot 22 applies tension to the power transmission member 12 to remove excess slack. In operation, a check valve 30 controls the flow of hydraulic oil into and out of a high pressure chamber 10a of a hydraulic tensioner 10 to support a piston 10b in operable engagement with the tensioning arm 20 to maintain tension on the power transmission member 12 in order to remove excess slack. The check valve 30 in this figure may be any of the check valves described herein, including the integrated pressure relief valves shown in FIGS. 2-8 or the band check valve shown in FIGS. 9-12. It should be recognized that the hydraulic tensioner 10 disclosed herein can be used in other alternative configurations of tensioning arms without departing from the spirit or scope of the present invention, and that the illustrated configuration is by way of example only, and is not to be considered a limitation of the invention.

FIG. 2 shows an integrated pressure relief valve 70 in an embodiment of the invention. The integrated pressure relief valve 70 includes pressure relief valve components 71, 80, 82, 86, 99 and band check valve components 32 and 44. The integrated pressure relief valve 70 also includes a vent seal 84. The vent seal 84 is preferably a full ring seal or vent with multiple slots which allow fluid flow into a tortuous path. The band check valve 44, which is preferably made of metal, is placed around the circumference of the pressure relief valve body 71. This minimizes packaging spaces and simplifies the component part, resulting in a low cost design.

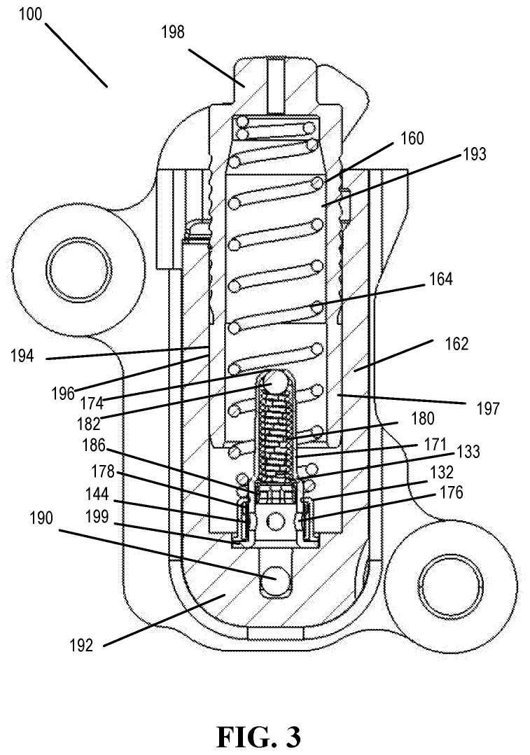

The band check valve 44 is placed around the outside of the pressure relief valve body 71. The band check valve 44 exerts a spring force on the pressure relief valve body 71. The pressure relief valve body 71 has a length that extends away from a band valve retainer 32 and includes a bottom extended portion 99 that sits on the vent seal 84. The band check valve 44 is disposed between a band valve retainer 32 and the pressure relief valve body 71. The side of pressure relief valve body 71 contains at least one through hole (176, 276 in FIGS. 3-5 and 6-8). The pressure relief valve spring 80 contacts the pressure relief valve member 82. While the valve member 82 is shown as a ball valve in the figures, it may have various geometric configurations. For example, the valve member 82 may be a disk or a tapered plug (not shown). The integrated pressure relief valve 70 also includes a pressure relief valve spring retainer 86 located between the pressure relief valve biasing member 80, which is preferably a spring, and the vent seal 84.

Forward flow (e.g. flow towards the pressure chamber) occurs through the band check valve 44, as shown by arrow 40 in FIG. 2. Fluid flows through the vent seal 84 from the inlet and supply, through holes (176, 276 in FIGS. 3-5 and 6-8, respectively) in the pressure relief valve body 71, exerting pressure on the band check valve 44 to move the band check valve 44 away from the pressure relief valve body 71 so that the fluid can travel out through holes 76 defined by the side wall and the top wall of the retainer 32. While not shown, the through holes could alternatively be defined by the retainer side wall or the retainer top wall only. Back flow (e.g. flow away from the pressure chamber) travels through the pressure relief valve, as shown by arrow 50 in FIG. 2. Pressure relief is provided through an aperture 74, moving the valve member 82 when a certain threshold pressure is reached, relieving pressure through the biasing member 80 towards the pressure relief retainer 86 and out a vent 79.

FIGS. 3-5 show one embodiment of an integrated pressure relief valve 170 in a hydraulic tensioner 100. The embodiment of FIGS. 3-5 differs from the embodiment of FIG. 2 in that the vent seal 84 in FIG. 2 is replaced by a hole 133. A tensioning arm is not shown in these figures but may be similar to the tensioner arm shown in FIG. 1. As shown in FIG. 3, the tensioner 100 includes a piston 160 and a piston housing 162. The piston housing 162 has a cylindrical bore 194 with an inner circumferential surface 196. The piston housing 162 also has an inlet 190 at an end 192 of the bore 194. The inlet 190 connects to a reservoir or an external supply of pressurized fluid (not shown). The cylindrical piston 160 is slidably received within the piston bore 194. The piston 160 includes a hollow cylindrical body 197 with a closed end 198.

A piston biasing member 164, which is preferably a spring, is received within the body of the piston 160. The piston biasing member 164, biases the piston 160 out of the piston housing 162 so that the tip of the piston can contact and push against the tensioner arm 20 as shown for the tensioner 10 in FIG. 1. A hydraulic pressure chamber 193 may be formed between the cylindrical bore 194 of the piston housing 162 and the hollow piston 160 and the piston biasing member 164.

The tensioner 100 also includes an integrated pressure relief valve 170. The integrated pressure relief valve 170 includes pressure relief valve components 171, 180, 182, 186, 199 and band check valve components 132 and 144. The integrated pressure relief valve 170 also includes a through hole 133. The through hole is preferably created using a laser and the through hole 133 replaces the vent seal shown in the embodiment of FIG. 2. The band check valve 144, which is preferably made of metal, is placed around the circumference of the pressure relief valve body 171. This minimizes packaging spaces and simplifies the component part, resulting in a low cost design.

The band check valve 144 is placed around the outside of the pressure relief valve body 171. The band check valve 144 exerts a spring force on the pressure relief valve body 171. The pressure relief valve body 171 has a length that extends away from a band valve retainer 132 and includes a bottom extended portion 199. The band check valve 144 is disposed between a band valve retainer 132 and the pressure relief valve body 171. The pressure relief valve body 171 contains at least one through hole 176. The pressure relief valve spring 180 contacts the pressure relief valve member 182. While the valve member 182 is shown as a ball valve in the figures, it may have various geometric configurations. For example, the valve member 182 may be a disk or a tapered plug (not shown). The integrated pressure relief valve 170 also includes a pressure relief valve spring retainer 186 located between the pressure relief valve biasing member 180, which is preferably a spring, and the hole 133.

Forward flow (e.g. flow towards the pressure chamber) occurs through the band check valve 144. Fluid flows from the inlet and supply, through holes 176 in the pressure relief valve body 171 exerting pressure on the band check valve 144 to move the band check valve 144 away from the pressure relief valve body 171 so that the fluid can travel out through holes 178 defined by the side wall and the top wall of the retainer 132. While not shown, the through holes could alternatively be defined by the retainer side wall or the retainer top wall only. Back flow (e.g. flow away from the pressure chamber) travels through the pressure relief valve. Pressure relief is provided through an aperture 174, moving the valve member 182 when a certain threshold pressure is reached, relieving pressure through the biasing member 180 towards the pressure relief retainer 186 and out a through hole 133.

It should be noted that the back flow from the pressure chamber 193 of the tensioner through the band check valve 144 is prevented by the band check valve 144.

FIG. 3 shows the tensioner 100 with the integrated check valve closed with no fluid vented or flowing into the hydraulic pressure chamber 193 of the tensioner.

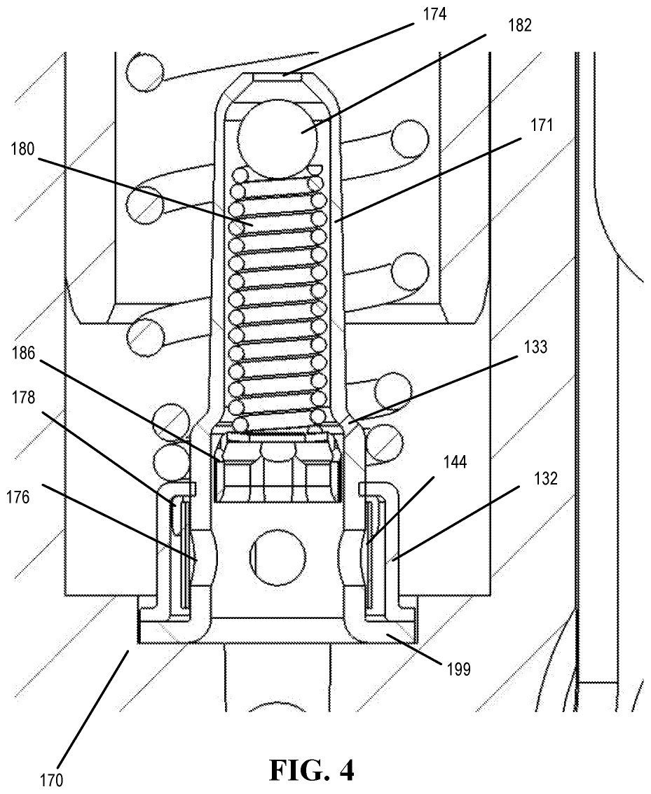

FIG. 4 shows the tensioner 100 with the pressure relief valve open, permitting back flow and pressure relief from the hydraulic pressure chamber 193.

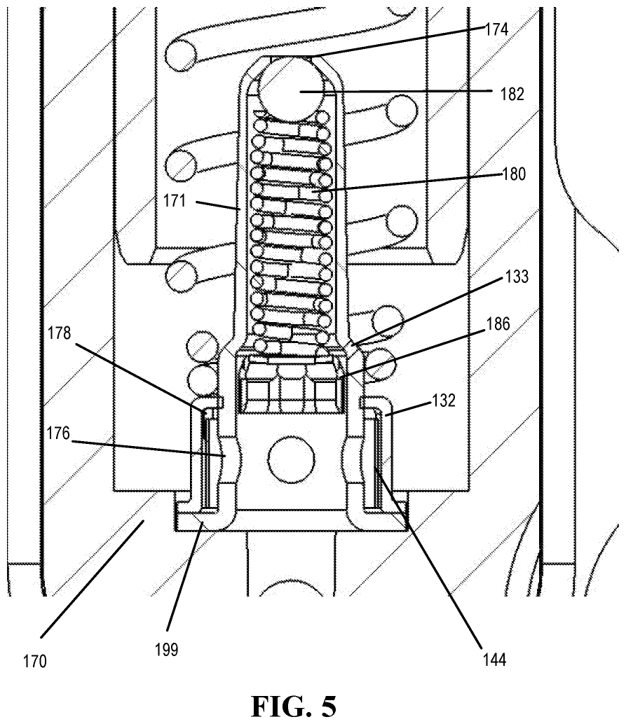

FIG. 5 shows the tensioner 100 with the band check valve 144 open, permitting forward flow through the check valve to the hydraulic pressure chamber 193 of the tensioner.

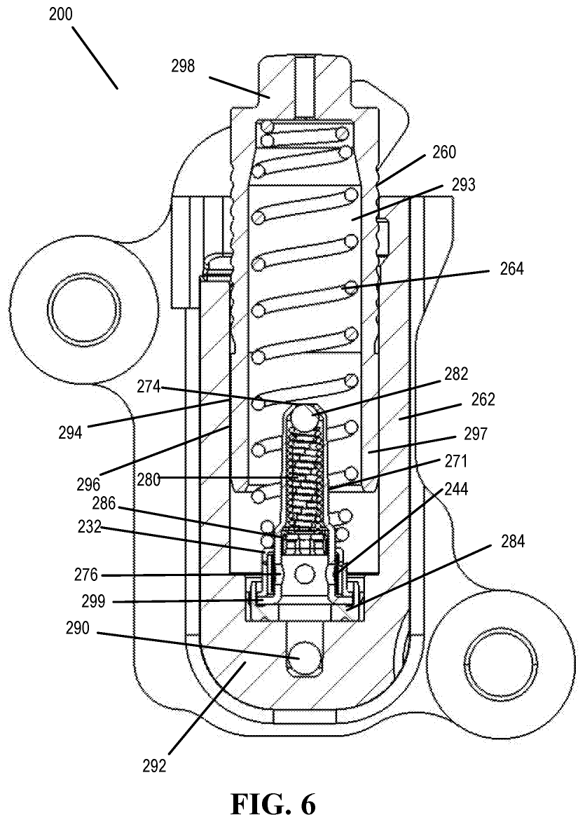

FIGS. 6-8 shows another embodiment of an integrated pressure relief valve 270 in a hydraulic tensioner 200. This embodiment preferably includes a vent seal 284, which is preferably made of plastic. A tensioning arm is not shown in these figures but may be similar to the tensioner arm shown in FIG. 1. As shown in FIG. 6, the tensioner 200 includes a piston 260 and a piston housing 262. The piston housing 262 has a cylindrical bore 294 with an inner circumferential surface 296. The piston housing 262 also has an inlet 290 at an end 292 of the bore 294. The inlet 290 connects to a reservoir or an external supply of pressurized fluid (not shown). The cylindrical piston 260 is slidably received within the piston bore 294. The piston 260 includes a hollow cylindrical body 297 with a closed end 298.

A piston biasing member 264, which is preferably a spring, is received within the body of the piston 260. The piston biasing member 264, biases the piston 260 out of the piston housing 262 so that the tip of the piston can contact and push against the tensioner arm 20 as shown for the tensioner 10 in FIG. 1. A hydraulic pressure chamber 293 may be formed between the cylindrical bore 294 of the piston housing 262 and the hollow piston 160 and the piston biasing member 264.

The tensioner 200 also includes an integrated pressure relief valve 270. The integrated pressure relief valve 270 includes pressure relief valve components 271, 280, 282, 286, 299 and band check valve components 232 and 244. The integrated pressure relief valve 270 also includes a vent seal 284. The vent seal 284 is preferably a full ring seal or vent with multiple slots which allow fluid flow into a tortuous path. The band check valve 244, which is preferably made of metal, is placed around the circumference of the pressure relief valve body 271. This minimizes packaging spaces and simplifies the component part, resulting in a low cost design.

The band check valve 244 is placed around the outside of the pressure relief valve body 271. The band check valve exerts a spring force on the pressure relief valve body 271. The pressure relief valve body 271 has a length that extends away from a band valve retainer 232 and includes a bottom extended portion 299 that sits on the vent seal 284. The band check valve 244 is disposed between a band valve retainer 232 and the pressure relief valve body 271. The pressure relief valve body 271 contains at least one through hole 276. The pressure relief valve spring 280 contacts the pressure relief valve member 282. While the valve member 282 is shown as a ball valve in the figures, it may have various geometric configurations. For example, the valve member 282 may be a disk or a tapered plug (not shown). The integrated pressure relief valve 270 also includes a pressure relief valve spring retainer 286 located between the pressure relief valve biasing member 280, which is preferably a spring, and the vent seal 284.

Forward flow (e.g. flow towards the pressure chamber) occurs through the band check valve 244. Fluid flows through the vent seal 284 from the inlet and supply, through through holes 276 in the pressure relief valve body 271 exerting pressure on the band check valve 244 to move the band check valve 244 away from the pressure relief valve body 271 so that the fluid can travel out through holes 278 defined by the side wall and the top wall of the retainer 232. While not shown, the through holes could alternatively be defined by the retainer side wall or the retainer top wall only. Back flow (e.g. flow away from the pressure chamber) travels through the pressure relief valve. Pressure relief is provided through an aperture 274, moving the valve member 282 when a certain threshold pressure is reached, relieving pressure through the biasing member 280 towards the pressure relief retainer 286 and out a vent 79 (shown in FIG. 2).

It should be noted that the back flow from the pressure chamber 293 of the tensioner through the band check valve 244 is prevented by the band check valve 244.

FIG. 6 shows the tensioner 200 with the integrated check valve closed with no fluid vented or flowing into the hydraulic pressure chamber 293 of the tensioner.

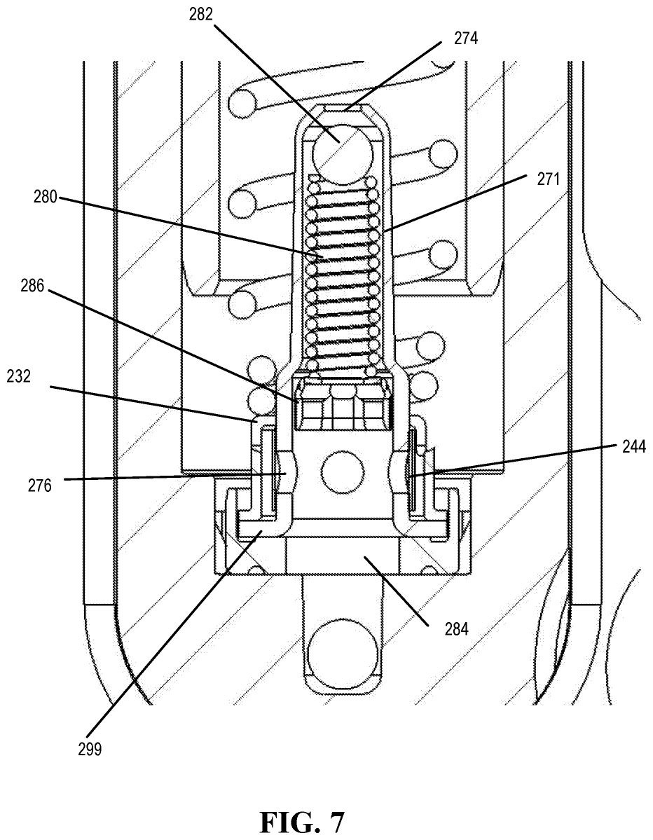

FIG. 7 shows the tensioner 200 with the pressure relief valve open, permitting back flow and pressure relief from the hydraulic pressure chamber 293.

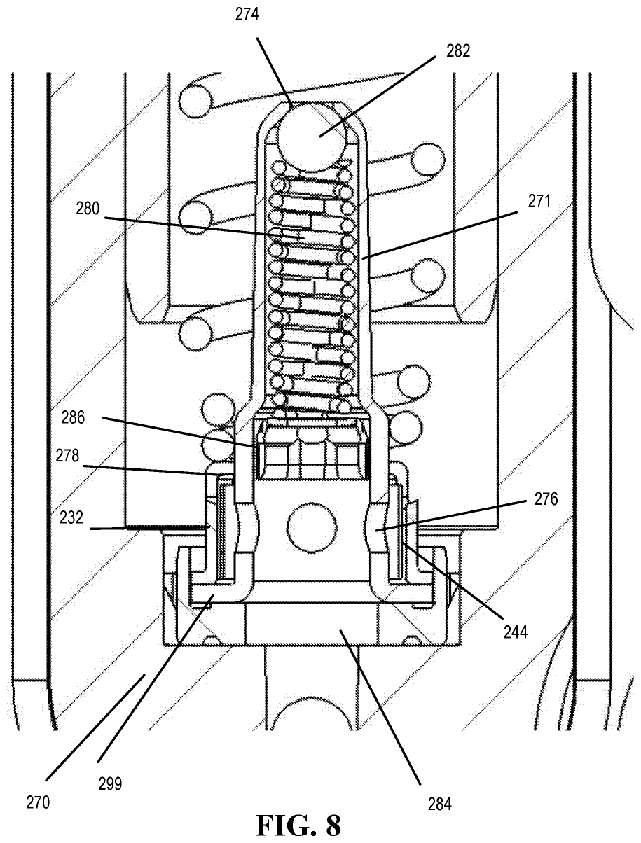

FIG. 8 shows the tensioner 200 with the band check valve 244 open, permitting forward flow through the check valve to the hydraulic pressure chamber 293 of the tensioner.

The integrated check valves preferably decrease space. For example, in some embodiments, the spring set height is decreased from 20 mm to 8 mm.

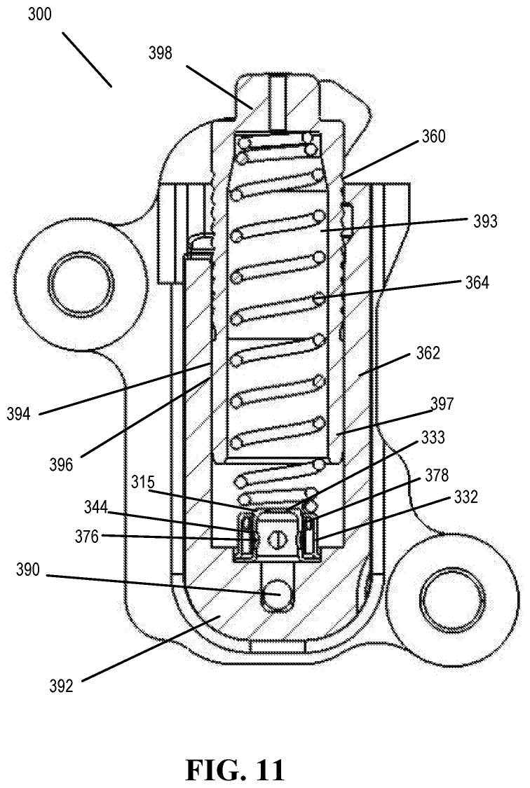

FIGS. 9-12 show a band check valve 344 alone in a hydraulic tensioner 300. There are no pressure relief valve components in this embodiment. However, there are one or more holes 333 in the valve body 315 that allow fluid flow from the pressure chamber back to the fluid source. In preferred embodiments, the holes 333 are created using a laser. A tensioning arm is not shown in these figures but may be similar to the tensioner arm shown in FIG. 1. As shown in FIG. 11, the tensioner 300 includes a piston 360 and a piston housing 362. The piston housing 362 has a cylindrical bore 394 with an inner circumferential surface 396. The piston housing 362 also has an inlet 390 at an end 392 of the bore 394. The inlet 390 connects to a reservoir or an external supply of pressurized fluid (not shown). The cylindrical piston 360 is slidably received within the piston bore 394. The piston 360 includes a hollow cylindrical body 397 with a closed end 398.

A piston biasing member 364, which is preferably a spring, is received within the body of the piston 360. The piston biasing member 364, biases the piston 360 out of the piston housing 362 so that the tip of the piston can contact and push against the tensioner arm 20 as shown for the tensioner 10 in FIG. 1. A hydraulic pressure chamber 393 may be formed between the cylindrical bore 394 of the piston housing 362 and the hollow piston 360 and the piston biasing member 364.

The tensioner 300 also includes a band check valve assembly 370. A band check valve 344 exerts a spring force on the inner valve body 315. The band check valve 344 is disposed between an inner valve body 315 and a band check valve retainer 332. Both the inner valve body 315 and the band check valve retainer 332 include through holes 376 and 378, respectively. The inner valve body 315 also includes a bottom portion 399.

Forward flow (e.g. flow towards the pressure chamber) occurs through the band check valve 344. Fluid flows from the inlet and supply, through holes 376 in the inner valve body 315, exerting pressure on the band check valve 344 to move the band check valve 344 away from the inner valve body 315 so that the fluid can travel out through holes 378 in the check valve retainer 332 as shown by arrow 340 in FIG. 12. The through holes in these figures are defined by the side wall 325 and the top wall 327 of the retainer 332. While not shown, the through holes could alternatively be defined by the retainer side wall or the retainer top wall only. Back flow from the pressure chamber 393 of the tensioner through the band check valve assembly 370 is prevented by the band check valve 344. The holes 333 in the valve body 315 allow fluid flow from the pressure chamber back to the fluid source, relieving pressure.

All patent and non-patent references discussed herein are hereby incorporated by reference in their entireties.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An integrated check valve for a hydraulic tensioner, comprising:
a) a pressure relief valve mechanism comprising:
a hollow pressure relief body defining a chamber, the pressure relief body having a first end with an aperture, a second end, and a length extending from a bottom portion;
a valve member received in the first end of the chamber;
a pressure relief retainer received in the second end of the chamber; and
a first biasing member received in the chamber having a second end contacting the pressure relief retainer and a first end contacting the valve member, the first biasing member biasing the valve member to a position in which the valve member seals the aperture of the pressure relief body; and
b) a check valve mechanism comprising:
a check valve retainer surrounding a portion of the length of the hollow pressure relief body comprising a retainer sidewall and a retainer top wall defining through holes, wherein the check valve retainer defines a cavity between the pressure relief valve body and the check valve retainer; and
at least one band check valve received within the cavity and extending around an outside of the pressure relief body between the top wall of the check valve retainer and the bottom portion of the pressure relief valve body.

2. The integrated check valve of claim 1, further comprising a vent seal adjacent the pressure relief valve mechanism defining a plurality of holes to permit forward and back flow of pressurized fluid.

3. The integrated check valve of claim 2, wherein the check valve mechanism provides forward flow of pressurized fluid through the integrated check valve such that fluid flows from a source through at least one hole in a side of the hollow pressure relief body and through the through holes of the check valve retainer and the pressure relief valve mechanism provides back flow through the integrated check valve such that fluid is relieved by flowing through the aperture of the pressure relief body, moving the valve member against the biasing member and flowing through the chamber and out the vent seal.

4. The integrated check valve mechanism of claim 1, wherein at least one first hole in the hollow pressure relief valve body permits back flow of pressurized fluid.

5. The integrated check valve of claim 4, wherein the check valve mechanism provides forward flow of pressurized fluid through the integrated check valve such that fluid flows from a source through at least one second hole in a side of the hollow pressure relief body and through the through holes of the check valve retainer and the pressure relief valve mechanism provides back flow through the integrated check valve such that fluid is relieved by flowing through the aperture of the pressure relief body, moving the valve member against the biasing member and flowing through the chamber and out the first hole.

6. The integrated check valve of claim 1, wherein the valve member is a ball.

7. The integrated check valve of claim 1, wherein the biasing member is a spring.

8. A hydraulic tensioner for an endless loop, flexible, power transmission member for an internal combustion engine of a motor vehicle, comprising:
a housing having a bore, the bore having an inner surface, the housing having an inlet in communication with a source of pressurized fluid;
a hollow piston slidably received within the bore, the piston having an inner surface and an outer surface;
a piston spring biasing the piston in a direction toward the power transmission device;
a hydraulic pressure chamber formed between the inner surface of the bore, the inner surface of the hollow piston; and
an integrated check valve in a body of the housing, comprising a pressure relief valve mechanism and a band check valve mechanism surrounding a circumference of the pressure relief valve mechanism;
wherein the pressure relief valve mechanism permits transfer of pressurized fluid from the hydraulic pressure chamber to the source of pressurized fluid and the check valve mechanism permits transfer of pressurized fluid from the source of pressurized fluid to the hydraulic pressure chamber.

9. The hydraulic tensioner of claim 8, wherein:
the pressure relief valve mechanism comprises:
a hollow pressure relief body defining a chamber, the pressure relief body having a first end with an aperture, a second end, and a length extending from a bottom portion;
a valve member received in the first end of the chamber;
a pressure relief retainer received in the second end of the chamber; and
a first biasing member received in the chamber having a second end contacting the pressure relief retainer and a first end contacting the valve member, the first biasing member biasing the valve member to a position in which the valve member seals the aperture of the pressure relief body; and
the band check valve mechanism comprises:
a check valve retainer surrounding a portion of the length of the hollow pressure relief body comprising a retainer sidewall and a retainer top wall defining through holes, wherein the check valve retainer defines a cavity between the pressure relief valve body and the check valve retainer; and
at least one band check valve received within the cavity and extending around an outside of the pressure relief body between the top wall of the check valve retainer and the bottom portion of the pressure relief valve body.

10. The hydraulic tensioner of claim 9, wherein the integrated check valve further comprises a vent seal adjacent the pressure relief valve mechanism defining a plurality of holes to permit forward and back flow of pressurized fluid.

11. The hydraulic tensioner of claim 10, wherein the band check valve mechanism provides forward flow of pressurized fluid through the integrated check valve such that fluid flows from a source through at least one hole in a side of the hollow pressure relief body and through the through holes of the check valve retainer and the pressure relief valve mechanism provides back flow through the integrated check valve such that fluid is relieved by flowing through the aperture of the pressure relief body, moving the valve member against the biasing member and flowing through the chamber and out the vent seal.

12. The hydraulic tensioner of claim 9, wherein at least one first hole in the hollow pressure relief valve body permits back flow of pressurized fluid.

13. The hydraulic tensioner of claim 12, wherein the band check valve mechanism provides forward flow of pressurized fluid through the integrated check valve such that fluid flows from a source through at least one second hole in a side of the hollow pressure relief body and through the through holes of the check valve retainer and the pressure relief valve mechanism provides back flow through the integrated check valve such that fluid is relieved by flowing through the aperture of the pressure relief body, moving the valve member against the biasing member and flowing through the chamber and out the first hole.

14. The hydraulic tensioner of claim 9, wherein the valve member is a ball.

15. The hydraulic tensioner of claim 9, wherein the biasing member is a spring.

16. A band check valve assembly for a hydraulic tensioner, comprising:
a hollow cylindrical inner valve body having a length extending from a bottom portion and comprising a cylindrical inner valve body sidewall defining at least one through hole, and an inner valve body top wall;
a check valve retainer surrounding a portion of the length of the cylindrical inner valve body comprising a retainer sidewall and a retainer top wall defining through holes, wherein the check valve retainer defines a cavity between the cylindrical inner valve body and the retainer sidewall; and
at least one band check valve received within the cavity and extending around an outside of the hollow cylindrical inner valve body between the retainer top wall and the bottom portion of the cylindrical inner valve body.

17. The band check valve assembly of claim 16, wherein the band check valve assembly provides forward flow of pressurized fluid through the band check valve assembly such that fluid flows from a source through the at least one through hole in the inner valve body and through the through holes of the check valve retainer.

18. A hydraulic tensioner for an endless loop, flexible, power transmission member for an internal combustion engine of a motor vehicle, comprising:
a housing having a bore, the bore having an inner surface, the housing having an inlet in communication with a source of pressurized fluid;
a hollow piston slidably received within the bore, the piston having an inner surface and an outer surface;
a piston spring biasing the piston in a direction toward the power transmission device;
a hydraulic pressure chamber formed between the inner surface of the bore, the inner surface of the hollow piston; and
a band check valve assembly in a body of the housing, comprising:
a hollow cylindrical inner valve body having a length extending from a bottom portion and comprising a cylindrical inner valve body sidewall defining at least one through hole, and a inner valve body top wall;
a check valve retainer surrounding a portion of the length of the cylindrical inner valve body comprising a retainer sidewall and a retainer top wall defining through holes, wherein the check valve retainer defines a cavity between the inner cylindrical inner valve body and the retainer sidewall; and
at least one band check valve received within the cavity and extending around an outside of the hollow cylindrical inner valve body between the retainer top wall and the bottom portion of the cylindrical inner valve body.
wherein the band check valve assembly permits transfer of pressurized fluid from the source of pressurized fluid to the hydraulic pressure chamber.

19. The hydraulic tensioner of claim 18, wherein the band check valve assembly provides forward flow of pressurized fluid through the band check valve assembly such that fluid flows from a source through the at least one through hole in the inner valve body and through the through holes of the check valve retainer.
